(19) United States
(12) Patent Application Publication
(10) Pub. No.: US 2018/0221967 A1
(43) Pub. Date: Aug. 9, 2018

(54) DRILLING SYSTEM AND DRILL INSERT AND METHODS FOR HOLE DRILLING

(71) Applicant: Allied Machine & Engineering Corp., Dover, OH (US)

(72) Inventors: Robert E. McKinley, Akron, OH (US); Corey L. Lawrence, Dover, OH (US); Joseph P. Nuzzi, Dover, OH (US)

(21) Appl. No.: 15/889,433

(22) Filed: Feb. 6, 2018

Related U.S. Application Data
(60) Provisional application No. 62/455,005, filed on Feb. 6, 2017.

(51) Int. Cl. B23B 51/04

(52) U.S. Cl. CPC B23B 51/048; B23B 2251/02; B23B 2200/325; B23B 2251/50; B23B 2251/48

(57) ABSTRACT

There is provided a drilling assembly and drill insert for producing holes in metal workpieces, wherein the drill insert body has a cutting end. The cutting end comprises at least two cutting lips formed transverse to each other. A web is formed between the two cutting lips, and each of the two cutting lips includes a cutting edge segment and at least one chip breaker. The chip breaker comprises at least one step in the cutting lip to produce a radial discontinuity in the cutting edge segment of the cutting lip for producing chips during machining which are of a width that is sufficiently reduced to allow proper evacuation from the hole produced thereby.

### CROSS REFERENCE TO RELATING APPLICATION

This non-provisional application claims priority to and the benefit of U.S. Provisional Patent Application Ser. No. 62/455,005, filed on Feb. 6, 2017, which is incorporated herein by reference in its entirety.

### FIELD OF THE INVENTION

The present invention relates to the field of drilling, and in particular, to hole drilling systems, which produce holes in an accurate and effective manner while preserving the life of the drill insert.

### BACKGROUND INFORMATION

In drilling systems used for drilling holes or in other machining processes in metal or like workpieces, there is a need to form the hole in an effective and efficient manner. For the purpose of drilling holes into metal materials, it has been customary to employ spade drills. Spade drills have been developed that use a flat, generally rectangular sheet of hard material such as carbide, that is attached to a holder body as a drilling insert, allowing replacement of the spade drill insert after wear. Such spade drill inserts are imparted with a V-shape on one side. The V-shape constitutes the point of the drill when assembled with a holder, and generally includes various cutting geometries for proper penetration into the workpiece. Spade drills are known for their characteristic of providing economical means for producing holes in metal. As the tool becomes worn from use, the insert can be quickly and economically replaced with another insert. In many applications, this is preferable to conventional twist drills which are either expensive to replace or must be resharpened through a time-consuming process.

For metal drilling operations to be successful, the process must produce shavings or chips as the material is machined, with chips formed in a controlled manner as the drill penetrates the workpiece. The chips must be of a size small enough to be easily evacuated from the hole as it is drilled. To achieve this, with reference to FIG. 1, the cutting edges 5 of a spade drill are often imparted with notches 6 in the cutting edges called chip splitters or chip breakers. Chip breakers 6 create discontinuities in the cutting edge 5 which cause a reduction in the width of metal chips produced. These notches are of various shapes ranging from a half circle to a rounded V-shape.

The current design of chip breakers 6 have several shortcomings. Firstly, each notch 6 in the cutting edge 5 produces two vertices at the cutting edge 5 each of which is both a stress riser and heat concentrator. These vertices are prone to chipping of the insert substrate, leading to failure of the tool. Additionally, chip breakers 6 are required to be situated so as to be asymmetrical. This results in further problems, such as 1) the asymmetry is undesirable because each of the two cutting edge segments is subjected to differing cutting forces which negatively affects cutting dynamics, and 2) the gaps in each cutting edge segment cause corresponding areas on the opposing cutting edge segment that are subjected to the full feed rate of the tool. These are areas where the feed is not equally shared by each of the two cutting edge segments and thus are subjected to greater forces resulting in greater local stresses.

Further, the internal flank surfaces of the chip splitters 6 are predisposed to impact the sides of the ridges left in the workpiece by the gaps in the cutting edge segments. This necessitates higher cutting forces and also results in higher local stress. These increased local stresses occur adjacent to stresses at the corner vertices of the chip breakers and to those stresses caused by full-feed exposure.

There thus is a need for a drilling tool that produces chips that are of a desired configuration and size small enough to be easily evacuated from the hole as it is drilled. There is also the need for a drilling tool wherein the formation of chips during the drilling process avoids the problems of producing vertices at the cutting edge segment and associated creation of stress risers and/or heat concentrators. It would also be desirable to provide a drilling tool wherein problems, such as creating differing cutting forces on the cutting edge segments and/or exposing portions of the cutting edge segments to the full feed rate of the tool can be avoided. Further yet, it would be desirable to avoid the creation of ridges in the machining process that necessitates higher cutting forces and results in higher local stresses imposed on portions of the cutting edge segments.

For many applications, there is a need for tooling that can effectively produce holes with production of chips in a desired manner dependent on the type of material being machined. Types of metal materials produce different chips based on the ductility and other characteristics. It would be desirable to provide a drilling tool that allows chip formation to be tailored to the type of material. It would also be desirable to provide a drilling tool that allows for the flow of formed chips to be controlled for proper evacuation from the hole during machining.

### SUMMARY OF THE INVENTION

The invention is directed to a drill insert for producing holes in metal workpieces comprising a drill insert body having a cutting end. The cutting end comprises at least two cutting lips formed transverse to each other. A web is formed between the two cutting lips, and each of the two cutting lips includes a cutting edge segment and at least one chip breaker. The chip breaker comprises at least one step in the cutting lip to produce a radial discontinuity in the cutting edge segment of the cutting lip for producing chips during machining which are of a width that is sufficiently reduced to allow proper evacuation from the hole produced thereby.

In another aspect of the invention, there is provided a drilling tool assembly comprising a holder having first and second ends and a rotational axis. The second end is adapted to be fixedly attached in a drilling machine, and the first end has at least one drill insert mounted thereon. The drill insert has a cutting end having at least two cutting lips formed transverse to each other, with a web formed between the two cutting lips. The two cutting lips include at least one chip breaker comprising at least one step to produce a radial discontinuity in the cutting edge segment of the cutting lip for producing chips which are of a width that is sufficiently reduced to allow proper evacuation from the hole.

Other aspects of the invention will be apparent to those of skill in the art in view of the following written description and drawings relating to examples of the invention.

### BRIEF DESCRIPTION OF THE DRAWINGS

FIG. 1 shows a side view of a prior art cutting edge segment with chip breakers formed therein.

FIG. 2 shows a perspective a drilling assembly including the drill insert according to a first example of the invention.

FIG. 3 shows a perspective view of the drill insert in the example of FIG. 2.

FIG. 4 shows a side view of the drill insert in the example of FIG. 3.

FIG. 5 shows top view of the drill insert in the example of FIG. 3.

FIG. 6 shows a perspective view of the insert in the example of FIG. 3 mounted in a holder.

FIG. 7 shows a perspective view of another example of a drill insert according to the invention.

FIG. 8 shows a side view of the drill insert in the example of FIG. 7.

FIG. 9 shows top view of the drill insert in the example of FIG. 7.

FIG. 10 shows a perspective view of another example of a drill insert according to the invention.

FIG. 11 shows a side view of the drill insert in the example of FIG. 10.

FIG. 12 shows top view of the drill insert in the example of FIG. 10.

FIG. 13 shows a partial view of the outboard cutting edge segment area of the cutting lip in the example of FIG. 10.

FIG. 14 shows a perspective view of the example of drill insert in the example of FIG. 10.

FIG. 15 shows another perspective view of the example of drill insert in the example of FIG. 10.

FIG. 16 shows another perspective view of the example of drill insert in the example of FIG. 10.

FIG. 17 shows a perspective view of another example of a drill insert according to the invention.

FIG. 18 shows a side view of the drill insert in the example of FIG. 17.

FIG. 19 shows top view of the drill insert in the example of FIG. 17.

FIG. 20 shows a partial view of the outboard cutting edge segment area of the cutting lip in the example of FIG. 17.

FIG. 21 shows a perspective view of another example of a drill insert according to the invention.

FIG. 22 shows a side view of the drill insert in the example of FIG. 21.

FIG. 23 shows top view of the drill insert in the example of FIG. 21.

FIG. 24 shows an end view of the drill insert in the example of FIG. 21.

FIG. 25 shows a perspective view of another example of a drill insert according to the invention.

FIG. 26 shows a side view of the drill insert in the example of FIG. 25.

FIG. 27 shows top view of the drill insert in the example of FIG. 25.

FIG. 28 shows a perspective view of an example of a drill insert according to the invention and metal chips produced thereby.

### DETAILED DESCRIPTION

The invention provides significant improvement in the robustness and overall performance of drilling products, by producing manageable metal chips with fewer concentrations of stress and heat on the cutting lips and cutting edge segments of the tool. This allows the tool to perform at higher penetration rates and provide longer tool life. The primary method by which chip splitting is achieved in the invention is the introduction of one or more steps into the cutting lips of the insert to form cutting edge segments. The step(s) provide a radial discontinuity in the cutting edge segment for producing chips which are of a width that is sufficiently reduced to allow proper evacuation from the hole. This at least one step reduces the number of vertices, (which are areas of high stress and temperature), exposed to the forming chips during the drilling process.

Cutting lips produced in accordance with the invention provide several advantages. They allow for a larger chip-forming zone because the structure of the lip is situated deeper into the insert. This larger chip forming zone provides improved flexibility for optimizing its shape to be suitable for a variety of applications including various workpiece materials and machining parameters.

Also by separating the cutting edge into segments, each segment may have its own chip-forming zone, and each chip forming zone with its own geometry. Thus, the geometry of each individual cutting edge segment can be optimized according to its diametric position on the insert. Cutting lips situated radially more outwardly may have increased or reduced axial rake angles or differing radius size and position versus the inwardly positioned lip. This contributes to improved performance of the tool.

Further, because the stepped cutting edge segments of the invention do not have gaps which leave behind uncut material to be removed by the opposing cutting edge, they can be designed in a symmetrical fashion. Symmetrical lip geometry spreads chip load evenly across all edges, as each cutting edge segment is exposed to forces equal and opposite those of the matching cutting edge segment on the other side of the insert. In addition, the cutting load is balanced across the matching cutting edge segments, and there are no areas which are subjected to the full feed of the cutting process. This allows the drill to be operated at greater penetration rates.

In a further example, the design allows the use of rounded corners and edges at the intersections of the flank surfaces of the lips which, to further reduce concentrations of stress and heat during operation.

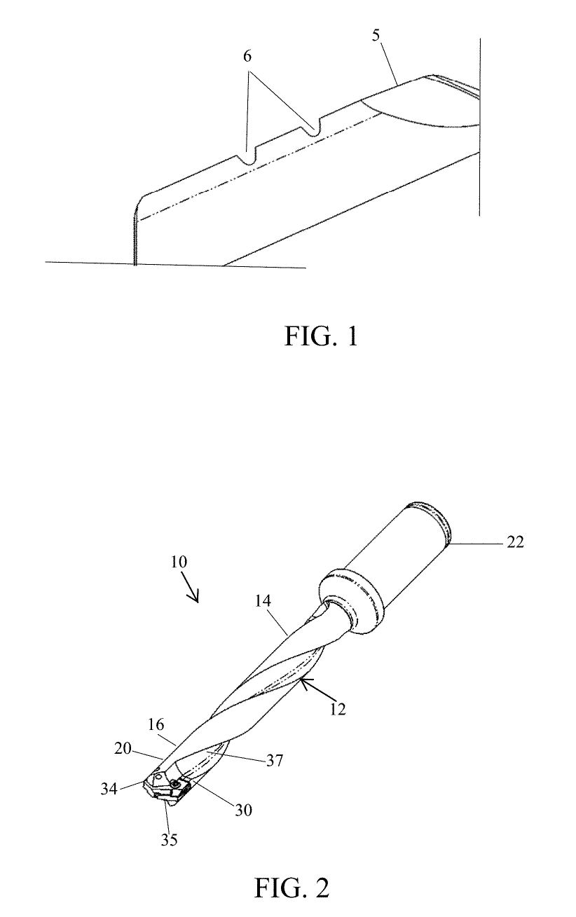

The invention also provides the ability to maximize the cross-sectional mass in areas of the cutting edge segments that produce segmentation of the chip. In conventional chip breaker design as shown in FIG. 1, the edges of the chip breaker, which are generally perpendicular to the single cutting edge, are acute with respect to the predominate direction of the local cutting forces. The drilling insert design of the invention allows these areas to be bolstered by material of obtuse cross-section in this respect, thereby distributing stress and thermal loads more favorably. This obtuse angle may be designed to be the maximum angle that can be achieved without introducing contact between the flank surface of the cutting lip and the forming chip. The angle required to achieve this varies according to the height of the step between the adjoining lip segments. As will be described in more detail, the flank surfaces of the cutting lip need not be flat. The surface may also be of a convex shape to further maximize the material cross-section in these areas. Cutting lip geometry may be constructed with varied rake angles, even across each segment, so that each axial element of the cutting edge segment is itself optimized to provide optimum chip-forming geometry at every radial position within the segment. The lips may likewise be constructed with varying radius for each axial element. Also, the cutting edge segments may be curved in either a convex or concave manner. Further, the general shape of each lip may consist of non-primitive geometry thus optimized for cutting at each location on its edge and for any given specific application. The geometry of the lip may also be designed to affect the manner in which the chips formed by it tend to flow. In an example, the shape is designed to predispose the chips to an inward curvature toward the center axis of the insert and to impart it with a sufficient strain that it will have a tendency to straightforwardly segment into short pieces that are easily evacuated from the hole.

As will be described in more detail, the design of the cutting lip according to the invention is not affected by the means of incorporating a step into the cutting lip. The chip-splitting effect can alternatively be achieved by increasing the height of lip segments. The lips may even be raised to a height exceeding the main thickness of the insert. The drilling insert of the invention is design may be produced by any of a variety of manufacturing methods including machining, pressing, injection molding, and other suitable methods.

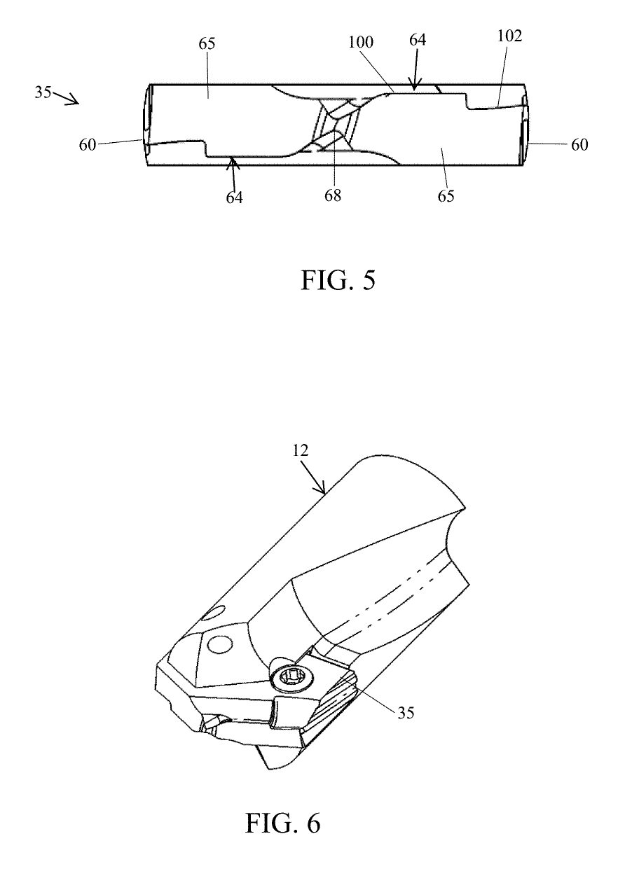

Turning to the FIGS., examples of a drilling system according to the invention are set forth. A first example of the drilling insert is shown in FIGS. 2-5, the drilling system 10 comprises a holder 12, which has a body 14 and head portion 16 associated therewith. In the preferred embodiment, holder 12 has, in general, a cylindrical shape with a first end 20 and second end 22. As shown in FIG. 2, the first end 20 of holder 12 has a clamping or holder slot 30, which may extend across the entire diameter of the head portion 16 or, at least, over a center portion thereof at the general location of the rotational axis of holder 12. The holder slot 30 has a bottom wall positioned in substantially perpendicular orientation relative to the rotational axis of the holder 12. The holder 12 may further include a locating boss or dowel pin, which is positioned precisely with respect to the rotational axis and extends from the bottom wall of the holder slot 30. Alternatively, the locating boss, may be configured as an integral member extending from bottom wall and positioning a drill insert 35 precisely with respect to the holder 12 to perform the desired drilling function in conjunction therewith. The drilling insert 35 has a point geometry comprising a plurality of cutting surfaces, which are precisely positioned with respect to the rotational axis of the holder 12 to minimize errors in a resulting drilling operation using assembly 10.

More particularly, the preferred embodiment of holder 12 is shown in FIG. 2, and may be configured to include at its first end 20 a pair of clamping arms 34, which extend about holder slot 30. The clamping arms 34 include holes, which accommodate screws to secure the drill insert 35 in its position within the holder slot 30. The holes are threaded to engage screws, and mate with screw holes formed in the drill insert 35 in a predetermined manner to precisely locate the drill insert 35 in a predetermined location within holder slot 30. Each of the clamp arms 34 may also include a lubrication vent, which allows the application and flow of lubrication adjacent the cutting surfaces of the drill insert to facilitate the drilling operation. The clamp arms 34 may also include angled or curved surfaces, which facilitate chip removal via chip evacuating grooves 37 on each side of the holder 12. The seating surface is shown to be designed as a planar surface, which corresponds to the planar bottom portion of the drill insert 35, although another configuration of bottom surfaces may be employed and is contemplated herein.

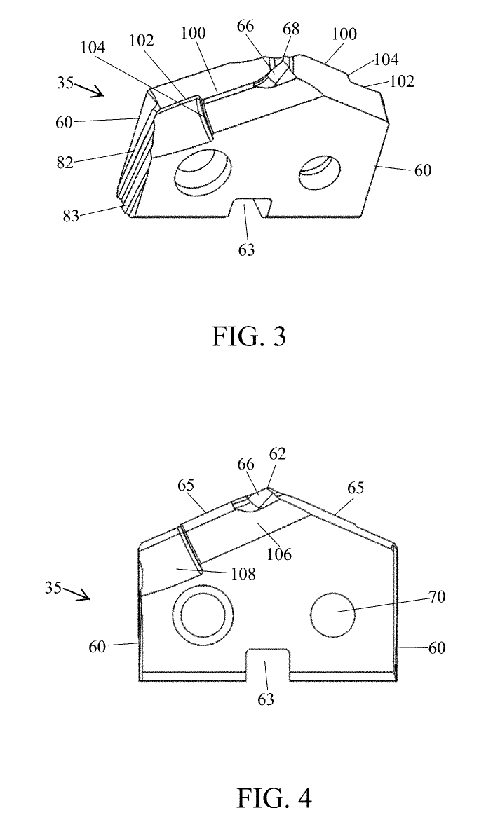

Turning to FIGS. 3-6, a first embodiment of the drill insert 35 is shown. The drill insert 35 may be formed as a spade drill blade, with side edges 60 of the blade being generally parallel with the rotational axis of the holder 12 once the insert 35 is positioned and secured with holder 12. When secured with holder 12, drill insert 35 will also have a rotational axis, which desirably is coaxial with axis of holder 12. The drill insert 35 has a width, which, upon being rotated with holder 12, forms an outside diameter of the assembled tool. The drill insert 35 further includes cutting lips 65 with cutting edges 64 on its upper surface in the form of an obtuse V-shape. The cutting edges 64 are on each side of the axial center 62, also known as the dead center, and a clearance surface is formed behind the cutting edges 64. The cutting edges 64 may include a plurality of cutting components, which cooperate together to provide the desired cutting surface for the material and/or drilling application. In general, the insert 35 is designed to cut when rotationally driven in conjunction with holder 12 in a predetermined direction. The drill insert 35 further includes apertures 70, which cooperate with the apertures in clamp arms 34 to secure insert 35 within holder slot 30 and seated against the seating surface. Additionally, each of the apertures 70 are preferably formed with countersunk portions formed as a bearing surface adapted to be engaged by a corresponding tapered or like surface on the screws or other fastening mechanisms. By offsetting the axes of the apertures 70 with corresponding apertures in the clamp arms, upon securing insert 35 within slot 30 by means of screws 38, the insert 35 will be forced downwardly against the seating surface. Insert 35 may include a locating slot 63, which allows positioning of a locating pin therein. A suitable connection is further described in co-owned U.S. Pat. No. 5,957,635, which is herein incorporated by reference.

The drill insert 35 further comprises sides or lands 60 across the width of the insert 35, each side 60 comprising helically extending margins 82 and 83 along with radially inward positioned clearance surfaces adjacent the margins 82 and 83. The margin surfaces 82 and 83 are cylindrically formed about the rotational axis of the insert 35 and contacts the edges of the hole being drilled. The trailing side of the margins 82 and 83 are helical wherein the margin width is helically increased from the cutting edge segment on one side to the opposite side of the spade drill insert 35. The margin 82 extends from the upper cutting edge corner to the back corner of the insert width. The second margin 83 is provided to prevent chips from accumulating adjacent the margin 82, and also provides four point edge contact between the drilling insert 35 and the formed hole, thereby providing stabilization and better accuracy and finish. The helical margins 82 and 83 result in almost the entire radial width of the side 60 to be able to contact the hole at two locations. The helically extending margins 82 and 83 increase the stability of the assembled tool 10 in operation and help prevent excessive exit chatter.

Insert 35 also includes a V-notch feature 66 located on either side of the chisel 68, which is formed across the insert web and extends through axial center 62. The V-notch 66 forms a type of flute on either side of insert 35, which reduces the web and length of chisel 68. The V-notch 66 is formed having a small radius at the bottom of the notch, which extends outward from the radius center along linear legs forming the sides of the V-notch 66. This creates a positive rake along the cutting edge of the V-notch 66, which cuts the material by forming a chip and minimizes extrusion or deforming of the metal during cutting operations. The positive rake of the V-notch 66 allows the insert cutting surfaces to bite into the workpiece in a more aggressive fashion, which results in higher feed rates and increased stability while, at the same time, creating less heat generated at the tip of the insert 35. The V-notch 66 further helps improve the self-centering capability of the drill insert 35. Alternatively, the notch 66 can also be used with an insert having a self-centering configuration, wherein a multi-faceted chisel point 68 is created by a clearance cut along a longitudinal center line of insert 35, which is parallel to the cutting edges 64, or created by a diagonal clearance cut extending through the center point 62 of chisel 68 from each trailing edge corner. The insert 35 could also include a spur point, which may be formed by cam grinding the clearances on either side of the chisel 68 to create the spur.

In FIGS. 3-6, the insert 35 is shown in more detail, and includes an inboard cutting edge segment 100 and at least one outboard cutting edge segment 102. There is a step 104 provided between the inboard cutting edge segment 100 and at least one outboard cutting edge segment 102, which creates a radial discontinuity in the cutting edge segment for producing chips which are of a width that is sufficiently reduced to allow proper evacuation from the hole. Though step 104 shows the radial discontinuity which extends into the insert 35, the opposite could be utilized, wherein the radial discontinuity extends outwardly from the inboard cutting edge segment 100, such that the outboard segment 102 is above the inboard segment 100. Providing the inboard cutting edge segment 100 and at least one outboard cutting edge segment 102 allow for a larger chip-forming zone because the structure of the lip 65 is situated deeper into the insert 35. This larger chip forming zone provides improved flexibility for optimizing its shape to be suitable for a variety of applications including various workpiece materials and machining parameters.

Also by separating the segments of the cutting edge segment, each segment may have its own chip-forming zone, with the inboard cutting edge segment 100 having a chip forming zone 106, and outboard cutting edge segment 102 having a chip forming zone 108. Each chip forming zone 106 and 108 may be provided with its own geometry, and as seen in this example, the chip forming zone 108 of the outboard cutting edge segment 102 is oriented differently from chip forming zone 106. Thus, the geometry of each individual cutting edge segment 100 and 102 can be optimized according to its diametric position on the insert. Cutting lips situated radially more outwardly may have increased or reduced axial rake angles or differing radius size and position versus the inwardly positioned lip. This may contribute to improved performance of the tool. As an example, the rake angle of the inboard segment 100 may be 15 degrees, while the rake angle of the outboard segment 102 may be 18 degrees, or the angles may be varied within each segment. The step 104 is of a size that the expected chip size will be broken by the radial discontinuity. The length of the step 104 is selected such that the distance normal to the clearance surface is greater than the thickness of the expected chip based on feed rates and types of materials and deformation characteristics. For example, the step 104 may be configured to have a depth corresponding to the type of material, such as harder materials like alloy steels, or in relation to more elastic carbon steels.

The stepped cutting edge segments 100 and 102 also do not have gaps between them, which leave behind uncut material to be removed by the opposing cutting edge segment. In this manner, they can be designed in a symmetrical fashion. Symmetrical lip geometry spreads chip load evenly across all edges, as each cutting edge segment is exposed to forces equal and opposite those of the matching cutting edge segment on the other side of the insert. In addition, the cutting load is balanced across the matching cutting edge segments, and there are no areas which are subjected to the full feed of the cutting process. This allows the drill to be operated at greater penetration rates.

The stepped cutting edge segment design also allows the use of rounded corners and edges at the intersections of the flank surfaces of the lips associated with each cutting edge segment 100 and 102, to further reduce concentrations of stress and heat during operation. Further, the stepped cutting edge segments 100 and 102 allow for the ability to maximize the cross-sectional mass in areas of the cutting edge segment that produce segmentation of the chip. The step 104 between cutting edge segments 100 and 102 is formed as a draft angle away from the inboard cutting edge segment, which desirably has an obtuse cross-section with respect to the predominate direction of the local cutting forces, thereby distributing stress and thermal loads more favorably. This obtuse angle may be designed to be the maximum angle that can be achieved without introducing contact between the flank surface of the cutting lip and the forming chip. The angle required to achieve this varies according to the height of the step 104 between the adjoining lip segments 100 and 102 and the diametrical position of the step 104, with a greater obtuse angle available toward the center of the insert. Further, the flank surfaces of the cutting lip need not be flat. The surface may also be of a convex shape to further maximize the material cross-section in these areas.

The cutting lip geometry of the inboard and outboard cutting edge segments may be constructed with varied rake angles so that each axial element of the cutting edge segment 100 and 102 is itself optimized thus providing optimum chip-forming geometry at every radial position within the segment. The lips 65 may likewise be constructed with varying radius for each axial element. Also, the cutting edge segments 100 and 102 may be curved in either a convex or concave manner. Further, the general shape of each lip may consist of non-primitive geometry thus optimized for cutting at each location on its edge and for any given specific application. The geometry of the lip may also be designed to affect the manner in which the chips formed by it tend to flow. In an example, the shape is designed to predispose the chips to an inward curvature toward the center axis of the insert and to impart it with a sufficient strain that it will have a tendency to straightforwardly segment into short pieces that are easily evacuated from the hole. Alternatively, the geometry may be provided to cause chips formed by each segment 100 and 102 to flow away from each other and minimize interaction between the chips. The design of the cutting lip according to the invention is not affected by the means of incorporating a step 104 into the cutting lip. The chip-splitting effect can alternatively be achieved by increasing the height of lip segments as will be described hereafter. The lips may even be raised to a height exceeding the main thickness of the insert. It should also be understood that the characteristics of both the inboard and outboard cutting edge segments can be controlled and include features described in association with one or the other of the cutting edge segments.

Another advantage of the disclosed drilling system is a reduction in cost per hole. This may be realized in several different ways. When the drilling insert 35 is worn out or damaged, it is easily replaced in the holder body 12. The stepped cutting lip configuration also allows the tool to perform at higher penetration rates and provide longer tool life. The presently disclosed drilling system includes two effective cutting edge segments from the center to the OD. This design can offer a significant performance advantage over a single effective cutting tool. With two effective cutting edge segments, the system may allow doubling of the feed rate of a comparable single cutting edge segment design. This increased penetration rate reduces the time in the cut freeing up machine time. The arrangement according to the examples of the present invention provides various advantages and overcomes problems associated with prior systems. For example, the arrangement does not result in work hardening of the material adjacent the hole, as no significant forces are imposed on the sides of the formed hole. The cutting geometry provided by the insert 35 may comprise an included angle such that radial loads imposed by the system are minimized, and heat generation is also minimized, such that no embrittlement of the machined material occurs.

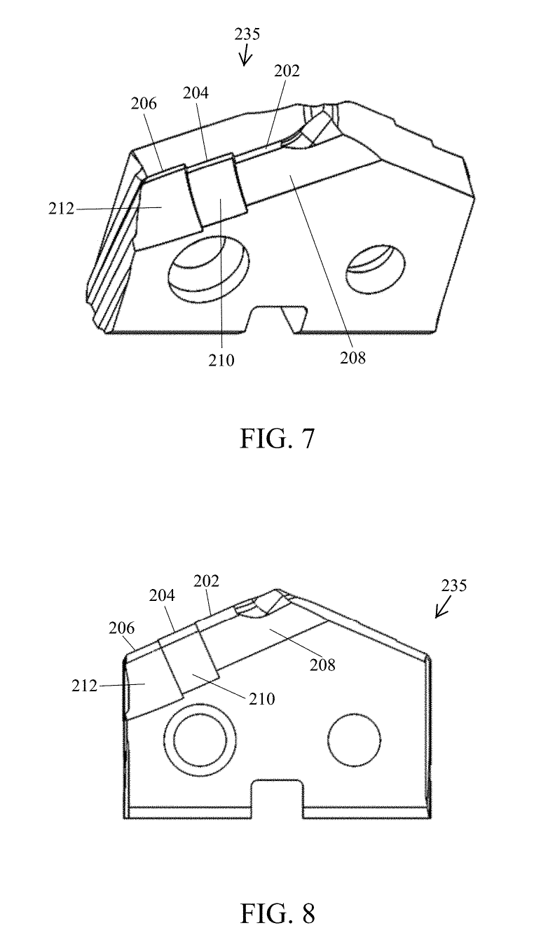

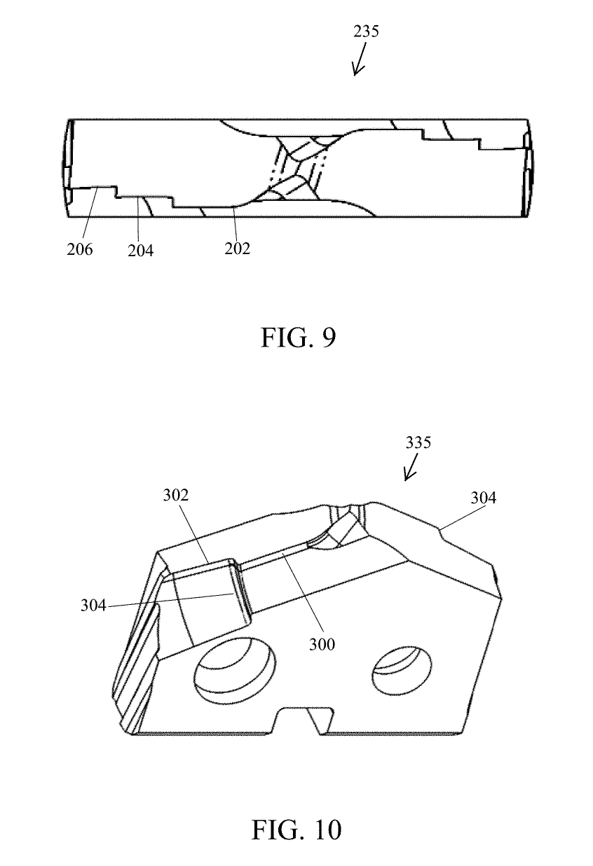

With reference to FIGS. 7-9, an alternative example is shown, wherein the drilling insert 235 includes a cutting lip configuration having an inboard cutting edge segment 202 and two stepped outboard cutting lips and associated cutting edge segments 204 and 206. Each cutting edge segment may have its own chip-forming zone, with the inboard cutting edge segment 202 having a chip forming zone 208, and first outboard cutting edge segment 204 having a chip forming zone 210, and the second outboard cutting edge segment 206 having a chip forming zone 212. Each chip forming zone 208, 210 and 212 may be provided with its own geometry. Thus, the geometry of each individual cutting edge segment 202, 204 and 206 can be optimized according to its diametric position on the insert. Similarly, each individual chip forming zone 208, 210 and 212 can be optimized to cause desired flow characteristics according to its diametric position on the insert cutting lips situated radially more outwardly may have increased or reduced axial rake angles or differing radius size and position versus the inwardly positioned lip.

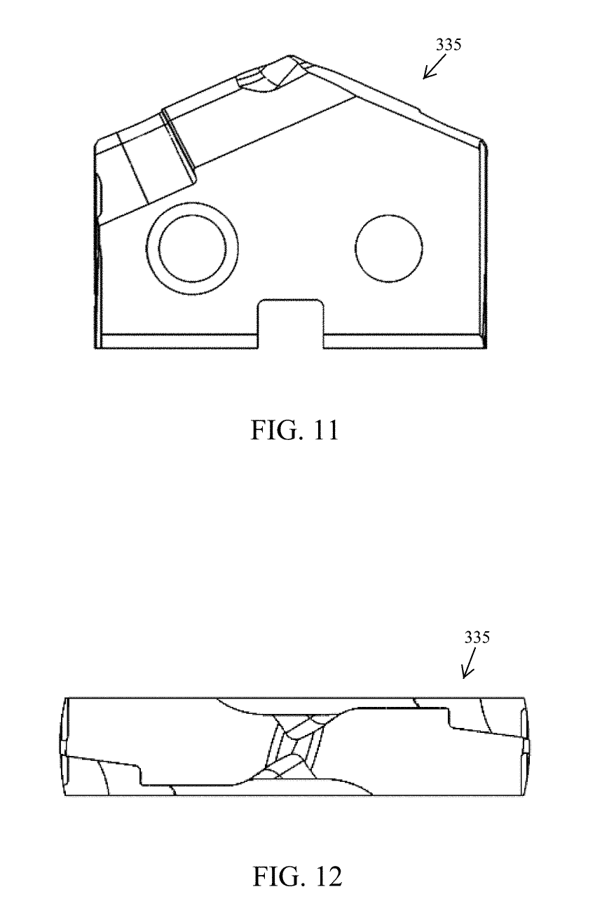

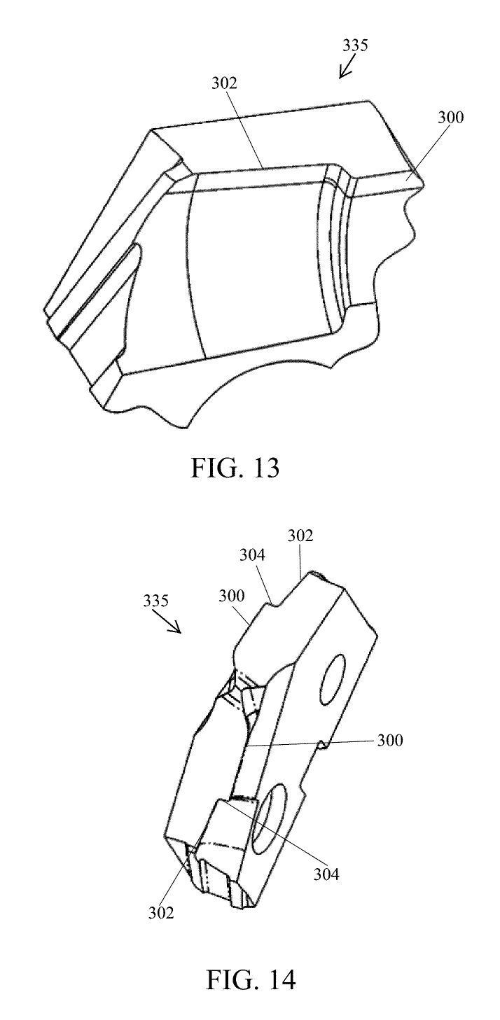

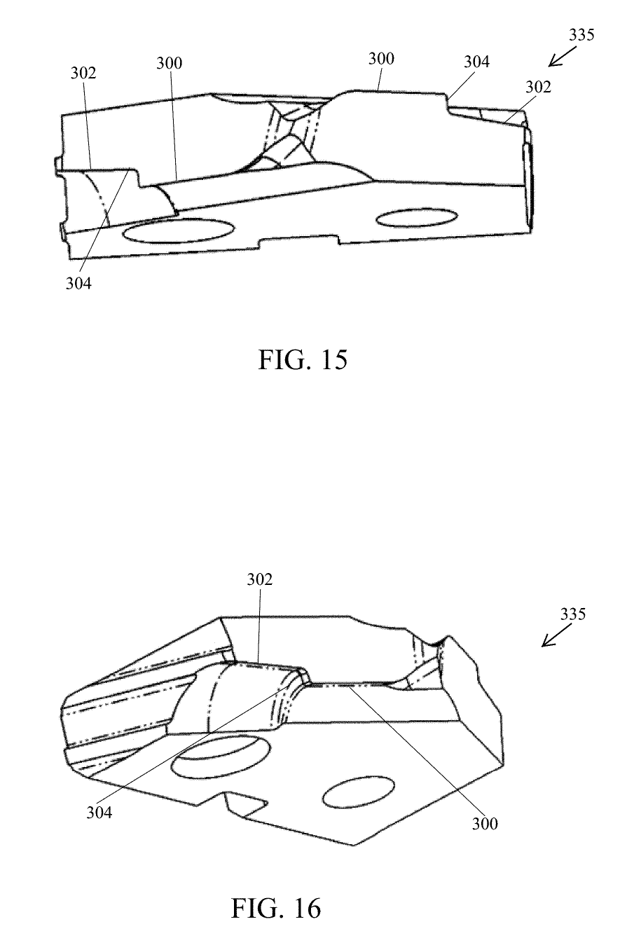

With reference to FIGS. 10-16, another example of the invention is shown. In this example, the drilling insert 335 includes cutting lips with an inboard cutting edge segment 300 and an outboard cutting edge segment 302, with a step 304 therebetween. In this example, the outboard cutting edge segments 302 are configured with negative radial rake angles, to facilitate directing chips formed thereby away from chips formed by segment 300, or to increase the strength of the cutting edge segment. The configuration of each of the segments 300 and 302 may allow formation of chips which curl away from one another to minimize interaction between the chips as they are formed. Alternatively, for some applications, it may be desirable to cause interaction between the chips formed by each segment 300 and 302, and the cutting edge segments 300 and 302 and chip forming zones can be configured to direct the flow of chips accordingly.

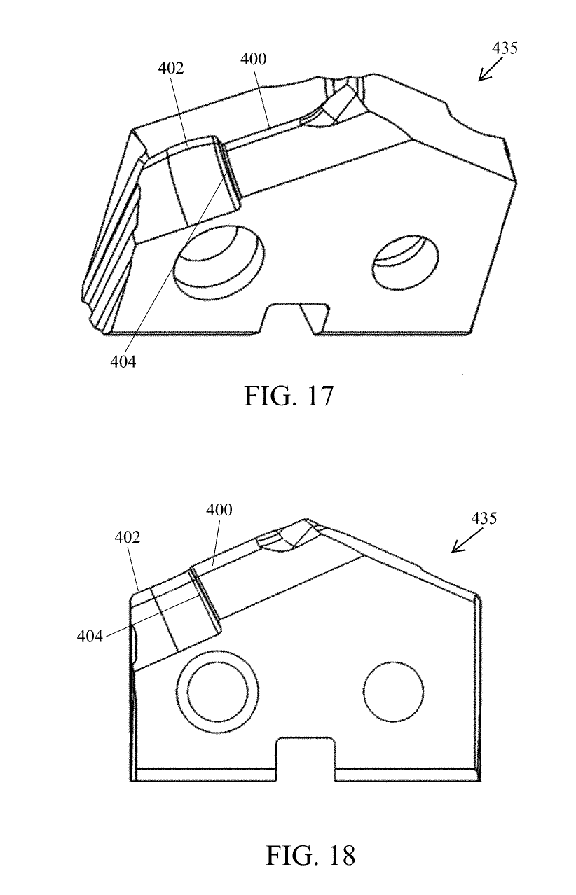

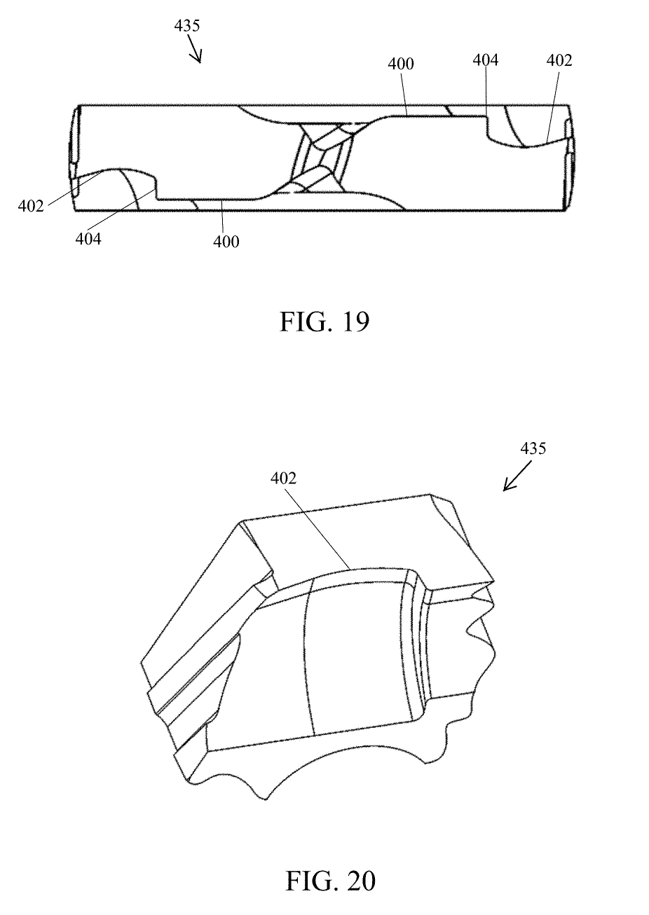

With reference to FIGS. 17-20, another example of the invention is shown. In this example, the drilling insert 435 includes cutting lips with an inboard cutting edge segment 400 and an outboard cutting edge segment 402, with a step 404 therebetween. In this example, the cutting edge segment 402 is formed as a curved cutting edge segment, or outboard positive radial hook type structure. In this arrangement, varying the rake angle across the segment can be used to facilitate desired chip formation and direction of curling and flow. In this example, the cutting edge segment 402 is shown to be concave, but may be curved in either a convex, concave, aspheric or combinational manner. Further, the general shape of each lip may consist of non-primitive geometry thus optimized for cutting at each location on its edge and for any given specific application.

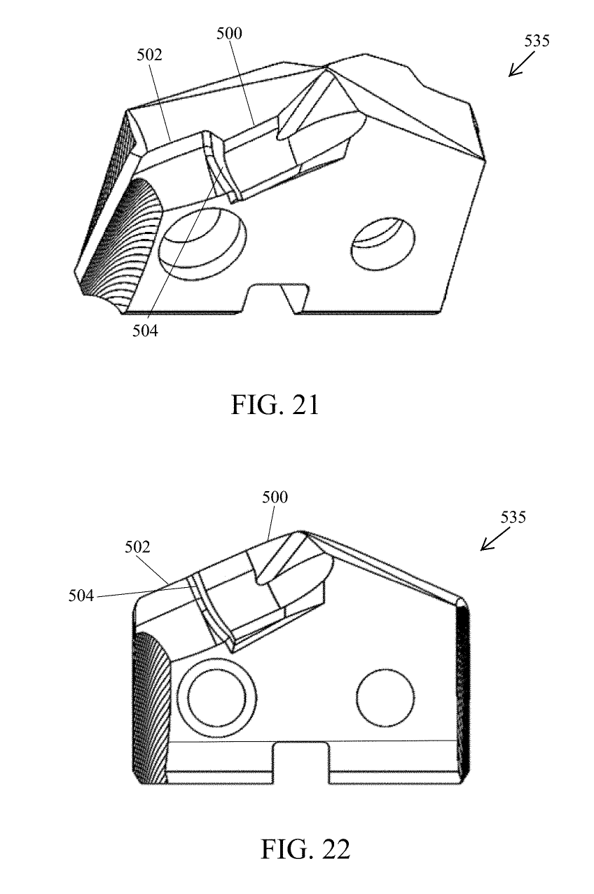

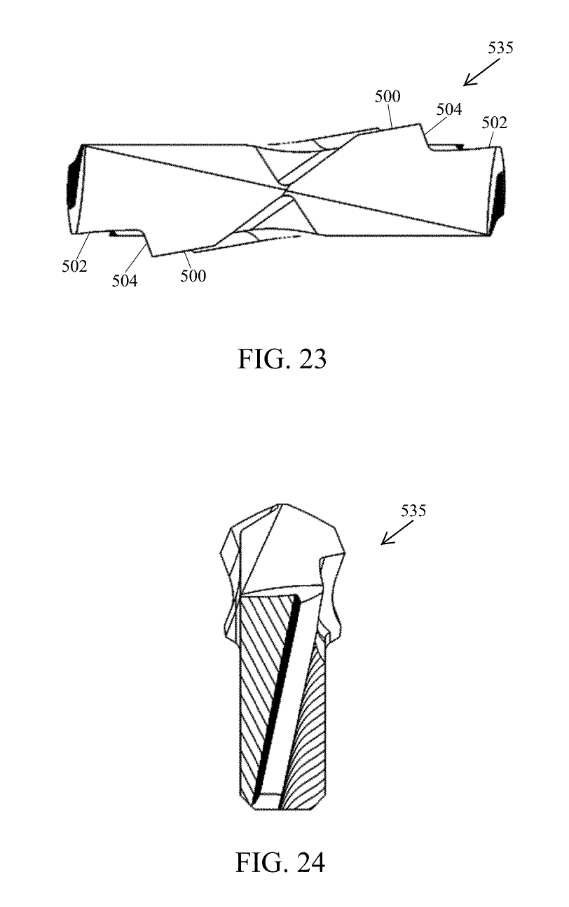

With reference to FIGS. 21-24, another example of the invention is shown. In this example, the drilling insert 535 includes cutting lips with an inboard cutting edge segment 500 and an outboard cutting edge segment 502, with a step 504 therebetween. In this example, the cutting lips are raised above the general thickness of the insert 535 at its bottom portion, to provide more material to support the cutting edge segments 500 and 502. In this example, the design of the cutting lip is not affected by the means of incorporating a step 504 into the cutting lip. The chip-splitting is achieved by increasing the height of lip segments, with the lips raised to a height exceeding the main thickness of the insert in this example. Also in this example, a single helical margin is provided instead of the double margin described in prior examples, and each can be used in any example herein as may be desired for a particular application.

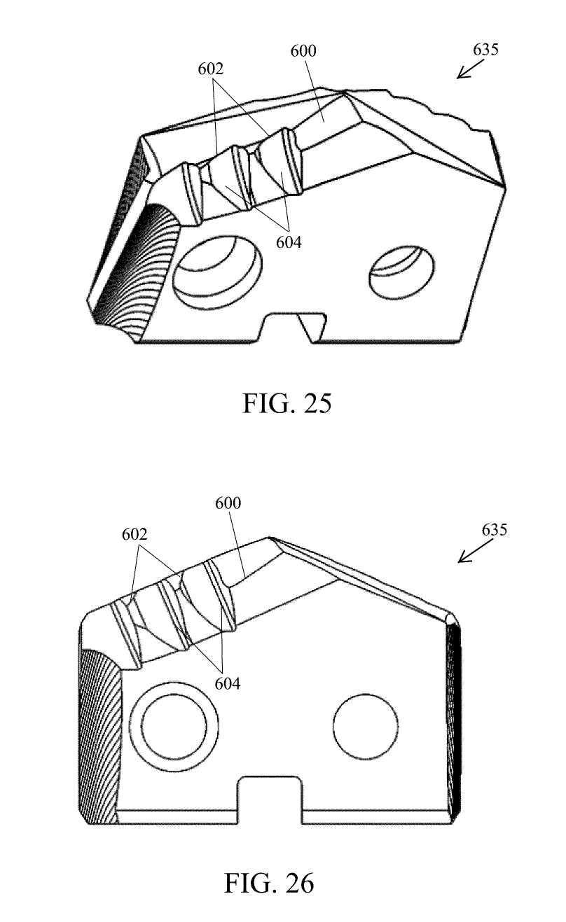

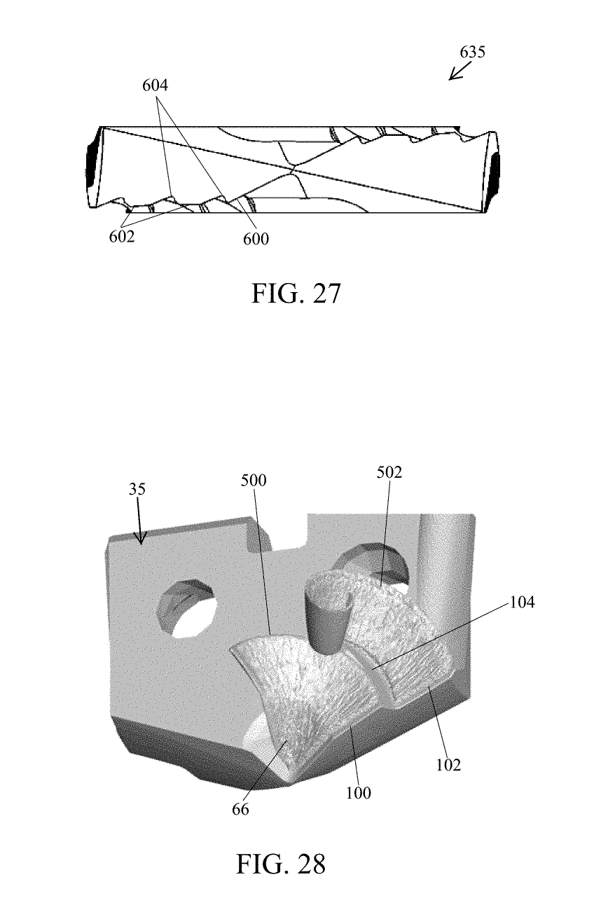

With reference to FIGS. 25-27, another example of the invention is shown. In this example, the drilling insert 635 includes cutting lips with a plurality of lip segments, creating a plurality of cutting edge segments including an inboard cutting edge segment an inboard cutting edge segment 600 and a plurality of outboard cutting edge segments 602, with steps 604 therebetween. The plurality of segments and separating the segments of the cutting edge segment, allows each segment to have its own chip-forming zone, and each may have its own geometry. Thus, the geometry of each individual cutting edge segment can be optimized according to its diametric position on the insert. Cutting lips situated radially more outwardly may have increased or reduced axial rake angles or differing radius size and position versus the inwardly positioned lip. This contributes to improved performance of the tool. Again in this example, a single helical margin is provided instead of the double margin described in prior examples, and each can be used in any example herein as may be desired for a particular application.

Referring now to FIG. 28, and with reference to the example of FIGS. 3-5, in operation, the drill insert 35 is rotated with the holder into machining engagement with a metal workpiece, and the inboard cutting edge segment 100 produces a first chip 500 in conjunction with the V-notch feature 66, which is broken at the radial discontinuity formed by the step 104 between cutting edge segment 100 and outboard cutting edge segment 102. The outboard cutting edge segment thus produces a separated chip 502, such that chips 500 and 502 are of a width that is sufficiently reduced to allow proper evacuation from the hole being drilled.

The configuration described herein and the particulars thereof can be readily applied to a variety of systems and applications. It is therefore understood that the above-described embodiments are illustrative of specific embodiments which can represent applications of the invention. Numerous and varied other arrangements can be made by those skilled in the art without departing from the spirit and scope of the invention.

What is claimed is:

1. A drill insert for producing holes in metal workpieces comprising: a drill insert body having a cutting end having at least two cutting lips formed transverse to each other, a web formed between the two cutting lips, each of the two cutting lips including at least one chip breaker comprising at least one step to produce a radial discontinuity in the cutting edge segment of the cutting lip for producing chips which are of a width that is sufficiently reduced to allow proper evacuation from the hole.

2. A drilling tool assembly comprising: a holder having first and second ends and a rotational axis, wherein the second end is adapted to be fixedly attached in a drilling machine, and the first end having a drill insert mounted thereon, the drill insert having a cutting end having at least two cutting lips formed transverse to each other, a web formed between the two cutting lips, each of the two cutting lips including at least one chip breaker comprising at least one step to produce a radial discontinuity in the cutting edge segment of the cutting lip for producing chips which are of a width that is sufficiently reduced to allow proper evacuation from the hole.

3. A cutting insert formed of a plate-like member with a substantially polygonal outer shape and comprising: a rake face; a flank formed on an outer peripheral surface extending between the top and bottom surfaces; with at least one chip breaker formed on a top surface of the plate-like member by at least one step formed along the rake face to produce an inboard cutting edge segment and at least one outboard cutting edge segment, wherein the step produces a radial discontinuity in the cutting edge segment of the rake face for creating separated chips from each inboard and outboard cutting edge segment which are of a width that is sufficiently reduced to allow proper evacuation from the hole.

4. A cutting insert comprising a plate-like member with a top and bottom surface, and a flank formed on an outer peripheral surface extending between the top and bottom surfaces, and at least two cutting edge segments formed transverse to each other on the second side, a web between the two cutting edge segments, and a web thinning notch formed on either side of the web; wherein each of the cutting edge segments include at least one step between the web and flank to produce an inboard cutting segment and at least one outboard cutting segment in association with each cutting edge segment, wherein the step produces a radial discontinuity in the cutting edge segment for creating separated chips from each inboard and outboard cutting segment which are of a width that is sufficiently reduced to allow proper evacuation from the hole.
